(19) United States
(12) Patent Application Publication
(10) Pub. No.: US 2022/0414275 A1
(43) Pub. Date: Dec. 29, 2022

(54) METHOD FOR GENERATING A STRUCTURE MESH, USE OF A STRUCTURE MESH, COMPUTER PROGRAM, AND COMPUTER-READABLE MEDIUM

(71) Applicant: SIEMENS INDUSTRY SOFTWARE NV, Leuven (BE)

(72) Inventors: Gaetan Compere, Bossière (BE); Boris Lauber, Eurasburg (DE)

(21) Appl. No.: 17/634,957

(22) PCT Filed: Aug. 14, 2019
(86) PCT No.: PCT/EP2019/071822

§ 371 Date: Feb. 11, 2022

(51) Int. Cl. G06F 30/10; B33Y 50/00; B22F 10/80

(52) U.S. Cl. CPC G06F 30/10; B33Y 50/00; B22F 10/80; G06F 2113/10

(57) ABSTRACT

A method for generating a structure mesh of a structure that is to be built-up in a three-dimensional build-up volume in an additive manufacturing build-up process. The structure includes at least one specimen and at least one support for supporting the at least one specimen on a boundary of the build-up volume. The structure mesh may be used in simulating the additive manufacturing build-up process of the structure 2. A use of a structure mesh 9, a computer program, and a computer-readable medium are also provided.

This application is the National Stage of International Application No. PCT/EP2019/071822, filed Aug. 14, 2019. The entire contents of this documents are hereby incorporated herein by reference.

### BACKGROUND

The present embodiments relate to generating a structure mesh of a structure that is to be built-up in a three-dimensional build-up volume in an additive manufacturing build-up process, use of such a structure mesh, a computer program, and a computer-readable medium.

A large number of additive manufacturing build-up processes (e.g., generative manufacturing or 3D printing processes) are known for the fast and cost-effective production of both prototypes and end products. These processes, which are summarized under the term rapid prototyping, enable, for example, the direct production of individual specimens (e.g., parts to print) based on digital construction data (e.g., CAD data) of the specimens. Production may be carried out using liquid, strip, wire, or powder starting materials, which is why there are few restrictions with regard to the specimen geometries and specimen materials. Thanks to the layer-by-layer production, previously unattainable geometries may be produced with these processes.

In the case of metallic powder starting materials, primarily two groups of additive manufacturing build-up processes are known. These are powder bed fusion based build-up processes, such as, for example, the Selective Laser Melting (“SLM”) process or the Selective Electron Beam Melting (“SEBM”) process, and powder feeding processes, such as, for example, the Laser Material Deposition (“LMD”) process.

In the SLM process, a metal powder to be processed is applied in a thin layer to a build-up platform and then completely melted locally using a laser radiation so that a solid material layer is formed after solidification. In order to enable a desired specimen to be manufactured in layers, the build-up platform is then lowered by the amount of one layer thickness, metal powder is applied again, and a laser beam is then directed over the new metal powder layer. This procedure is repeated until the desired specimen is completed. The SEBM process is almost identical to the SLM process, except that the metal powder is melted using an electron beam instead of laser radiation.

In addition to the processes already mentioned, there are also those in which the metal powder is melted using a plasma jet, to name just one example.

In the above mentioned additive manufacturing build-up processes, a specimen that is built-up in a three-dimensional build-up volume may have to be supported by a support connected to a boundary of the build-up volume (e.g., a build-up volume platform that defines a lower boundary of the build-up volume). Such a support is used to support areas of the specimen (e.g., areas of high overhang angles) typically larger than 45°. The support dissipates heat to the boundary of the build-up volume while the at least one specimen is built-up. In such cases, a structure includes the at least one specimen, and the at least one support is built-up in the three-dimensional build-up volume in the additive manufacturing build-up process.

Recently, simulation of the additive manufacturing build-up process of such structures becomes more and more important to avoid manufacturing of specimens that do not meet specified quality standards and/or deviate from a specified specimen shape. For example, it is known to carry out thermal, mechanical, and/or thermos-mechanical simulations of the additive manufacturing build-up process. This allows to get information on thermal issues during the later build-up and to capture a preview on distortions that may arise due to the complex thermo-mechanical process during the additive manufacturing build-up process. Further, with the help of such a simulation, it may be predicted how the at least one specimen will be deformed during a build-up process due to temperature influences. It may thus be assessed whether the at least one support is suitable for manufacturing the at least one specimen without or at least without critical heat deformation of the at least one specimen. The structure (e.g., the at least one specimen and the at least one support) is to be considered for both thermal simulation and mechanical analysis. Thus, a structure mesh is to be generated to simulate the behavior of the structure during the build-up process.

From EP 2 198 405 A1, US 2016/246908 A1, and KENJI SHIMADA ET AL: “Bubble mesh”, PROCEEDINGS OF THE THIRD SYMPOSIUM ON SOLID MODELING AND APPLICATIONS. SALT LAKE CITY, MAY 17-19, 1995; PROCEEDINGS OF THE SYMPOSIUM ON SOLID MODELING AND APPLICATIONS, NEW YORK, ACM, US, 1 Dec. 1995 (1995-12-01), pages 409-419, XP058190894, DOI: 10.1145/218013.218095, ISBN: 978-0-89791-672-1, respectively, aspects of meshing in connection with additive manufacturing are known.

Digital construction data (e.g., CAD data) for the at least one specimen are usually available such that at least one specimen mesh may be generated based on these digital construction data. For example, data that represent the at least one specimen meshed with an exact tetrahedron mesh or with a mesh based on voxelization technique may already be available. In case of an exact tetrahedron mesh, the geometry of the at least one specimen is approximated quite accurately as compared to the voxelization technique that results in a relatively rough approximation of the geometry of the at least one specimen.

The at least one support may have multiple shapes and structures and is usually relatively geometrically complex (e.g., compared with the at least one specimen). The at least one support is represented by surface data that describe a facetted surface of the at least one support. The facetted surface may consist of several facetted surface parts that are either connected to each other or separated from each other. The facetted surface may be formed by a plurality of triangles, for example. However, the surface data and the facetted surface are not meshable. Hence, the at least one support is to be treated and meshed as at least one solid structure, and then, a homogenized material may be used to correctly represent anisotropic behavior and at the same time have low degrees of freedom to have acceptable calculation times.

Accordingly, the existing surface data that describe a facetted surface of the at least one support is to be converted into data of at least one solid geometry (e.g., volume data) that may be meshed. So far, the generation of the solid geometry is done by extrusion of support faces and interpreting parameters, such as angled support information or distance to a build plate, of the facetted supports to a solid body. As a plurality of different support types and a large number of parameters exists, this “reverse engineering” approach is quite inrobust and often fails. In addition, only a few support types may be converted with the current method, which is a large limitation of the actual simulation capabilities.

Further, in existing methods for generating a structure mesh, a large computational effort is required to connect sub-meshes of the structure mesh that have been generated before.

The term “meshing” often used in this context, provides, for example, that a total area (e.g., either a surface or a volume) is divided into a finite number of subareas (e.g., discrete sections of the total area, also denoted as elements), and thus discretized. For example, a volume may be divided into cuboids, hexahedra, pyramids, or tetrahedral.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an alternative method for generating a structure mesh that does not have the disadvantages of the methods of the prior art is provided.

Although the following description of the present embodiments often refers to a powder bed fusion based build-up process, the present embodiments are not limited to this and may be applied equally in connection with any other additive manufacturing build-up process.

In one embodiment, a method includes providing a build-up volume surface mesh that represents a boundary of a three-dimensional build-up volume. At least one specimen mesh including a specimen surface mesh representing at least the outer surface of a corresponding specimen within an interior space surrounded by the build-up volume surface mesh is provided. A three-dimensional background mesh is created in the cavity between the build-up volume surface mesh and the at least one specimen surface mesh using the at least one specimen surface mesh as a seed mesh. The background mesh is composed of elements consisting of background mesh nodes and background mesh edges extending between the background mesh nodes. At least one support mesh and at least one environment mesh that is defined by the background mesh except for regions of the at least one support mesh are identified using the background mesh and surface data (e.g., STL data. STL is a file format native to the stereolithography CAD software created by 3D Systems. STL has several backronyms such as “Standard Triangle Language” and “Standard Tessellation Language”. This file format is supported by many other software packages; STL is widely used for rapid prototyping, 3D printing, and computer-aided manufacturing. STL files describe only the surface geometry of a three-dimensional object without any representation of color, texture, or other common CAD model attributes. The STL format specifies both ASCII and binary representations. Binary files are more common, since binary files are more compact. A facetted surface of the at least one support is described. The at least one support mesh and the at least one specimen mesh together define the structure mesh that is generated such that the at least one support mesh, the at least one specimen mesh, and the at least one environment mesh are connected with each other so that two neighboring meshes share the same nodes at their interfaces in their transition area.

Accordingly, the method of one or more of the present embodiments provides a meshing approach that resolves the problems associated with meshing the at least one support while maintaining the simulation accuracy in a later additive manufacturing build-up process simulation by keeping/using at least one specimen mesh that is usually a high quality mesh especially as a seed mesh. The seed mesh may be a two-dimensional seed mesh (e.g., a two-dimensional shell seed mesh) that may extend along at least one surface, such as a plane or a curved surface, in three-dimensional space. Using the at least one specimen surface mesh as a seed mesh results in nodes and edges of the part of the specimen surface mesh that represents the outer surface of the specimen to match background mesh nodes and background mesh edges at the outer boundary of the created background mesh. As the structure mesh as a whole is generated such that the at least one support mesh, the at least one specimen mesh, and the at least one environment mesh are connected with each other so that two neighboring meshes share the same nodes at their interfaces in their transition area, the computational effort required for interconnecting the at least one support mesh, the at least one specimen mesh, and the at least one environment mesh in state-of-the-art processes is no longer necessary. In the method of one or more of the present embodiments, all different meshes are implicitly and consistently connected. There is, for example, no need to create any geometrical brep model for at least one support sub-volume and/or at least one environment sub-volume of the build-up volume, and therefore, no need to explicitly create connections between the different meshes that would lead to massive problems for complex geometric components. The term “brep” stands for “boundary representation”, and brep models are known in the art. Further, the method of one or more of the present embodiments allows to robustly mesh any kind of structure that is to be built-up in an additive manufacturing build-up process and the environment surrounding the structure. Thus, as compared to prior art solutions, there is no limitation to any kind of structure and/or any type of support. Examples of supports that may be meshed with the method of one or more of the present embodiments are point supports, line supports, block supports, volume supports, cone supports, gusset supports, contour supports, and web supports to name just a few. If the additive manufacturing build-up process is a powder bed fusion-based build-up process, the environment mesh may be a powder mesh representing the powder used to build-up the structure. The term “STL data” may be data in STL file format, where the abbreviation STL stands for “stereolithography”. The term “identifying” used in the identifying of the at least one support mesh and at least one environment mesh may also be replaced by the term “capturing”.

According to the one or more of the present embodiments, providing the at least one specimen mesh includes providing at least one three-dimensional specimen mesh that represents a discretization not only of the surface of the at least one specimen but of the entire volume of the at least one specimen, and creating the three-dimensional background mesh includes discretizing the cavity with background mesh elements having the same size and/or shape as three-dimensional specimen mesh elements of the at least one three-dimensional specimen mesh. Alternatively or additionally, creating the three-dimensional background mesh includes creating a three-dimensional background mesh having background mesh elements that are tetrahedron-shaped, pyramid-shaped, hexahedron-shaped, and/or cuboid-shaped.

In general, the three-dimensional specimen mesh elements and the three-dimensional background mesh elements may have any three-dimensional shape.

Creating the three-dimensional background mesh may include creating a background mesh having smaller elements in a region of the build-up volume where the at least one support is expected to be located (e.g., in a region defined by a geometrical bounding box that encloses the at least one support and includes all elements thereof, and larger elements outside this region). In this way, regions that are primarily to be simulated later may be resolved higher than the remaining regions. The efficiency of the method of the present embodiments and the success of the identifying of the at least one support mesh and at least one environment mesh in identifying/capturing well the geometrical shape and details of the at least one support directly depends on the size of the background mesh elements. If the background mesh elements are larger than a thickness of the at least one support, the at least one support may not be fully identified/captured. If the background mesh has more background mesh elements than needed to properly identify/capture the at least one support, the method will be unnecessarily costly in terms of computational time.

In an embodiment, the identifying of the at least one support mesh and at least one environment mesh includes identifying surfaces (e.g., outer surfaces) of the at least one support within the background mesh by identifying points of intersection of the surfaces of the at least one support with background mesh edges, creating new nodes at the points of intersection, thus splitting the respective background mesh edges, and interconnecting at least some of the new nodes to create at least one support surface mesh. In other words, it is identified to which region(s) each background mesh node belongs (e.g., an environment/powder region or a support region) and if the respective background mesh node belongs to the boundary of a specimen. Then, the background mesh edges of the background mesh having background mesh nodes that do not all belong to a common region are split. New nodes created by the split operations are therefore at the boundary of at least two regions and will be considered as belonging to the regions of both nodes of the initial edge. As a consequence, all resulting elements fully belong to one region. The resulting at least one support surface mesh follows well the support shapes, even for shapes that are far from any canonic shape, extruded shape, or any relatively simple shape, and even if the at least one support is a very open structure (e.g., a structure without clear boundary walls). At least one support surface mesh is thus automatically connected to a specimen mesh and to the build volume surface mesh.

The surfaces of the at least one support identified in the identifying of the at least one support mesh and at least one environment mesh may be surfaces of a sub-volume of the build-up volume that represents the at least one support as simulated in contrast to the facetted surface of the at least one support described in the surface data (e.g., STL data) and/or in contrast to the at least one support as actually build-up in the additive manufacturing build-up process.

In one embodiment, the sub-volume of the build-up volume that represents the at least one support as simulated is defined as the set of points within the build-up volume that are located at a distance inferior to a threshold D to the closest facet of the facetted surface of the at least one support described by the surface data. The sub-volume thus corresponds to the solid geometry that is used instead of the pure surface data to represent the at least one support in later simulations. The threshold D may be defined in various ways. For example, the threshold D is chosen as the minimal distance such that any point located in the interior of the at least one support is at most at a distance d to the closest facet of the at least one support. The value of d corresponds to the value of D. If the at least one support is very regular, this choice may lead to a consistent volume region without any powder inclusion. If the threshold D is chosen too high, the later simulation of the at least one support becomes too inaccurate. If the threshold D is chosen too small, bubble meshes may arise. For supports that have a closed boundary or a nearly closed boundary (e.g., a fragmented boundary or a boundary with holes), such as, for example, grid-type supports, the value for D may be chosen to be smaller as compared to supports that have an open or more open boundary to limit the volume of the resulting at least one support mesh. The consequence may be that environment bubble meshes may be created inside the at least one support region, but these may be eliminated as described below.

Evaluating if a node is at a distance inferior to D to the at least one support structure may be accelerated by using spatial hashtables and/or RTrees.

It is possible that the identifying of the at least one support mesh and at least one environment mesh includes identifying an environment mesh (e.g., a powder mesh) that is an environment bubble mesh enclosed in a support mesh. The environment bubble mesh is eliminated by making the environment bubble mesh part of the support mesh in which the environment bubble mesh is enclosed. Additionally or alternatively, it is possible that the identifying of the at least one support mesh and at least one environment mesh includes identifying a support mesh that is a support bubble mesh not connected to the at least one specimen nor a build-up volume boundary. The support bubble mesh is eliminated by making the support bubble mesh part of the at least one environment mesh. The support bubble mesh may also not be connected to another identified support mesh and thus fully enclosed in an environment mesh. The bubble meshes may also be described as defects to be eliminated. The bubble meshes may be caused, for example, by the threshold D being chosen too small.

Especially after eliminating bubble meshes, at least one resulting support mesh may be modified to eliminate any undesirable offset obtained by at least one of the above acts. This may be achieved by computing a new support mesh boundary that is located at a distance E inside the initial support mesh boundary. The value of E may correspond to the value of D mentioned above. The interior of the resulting mesh boundary may be the new support mesh. In this way, a support mesh is obtained that more exactly matches the at least one support.

Especially after eliminating bubble meshes and/or after modifying at least one support mesh, at least one resulting mesh may be improved to meet a predefined element quality and element size.

The background mesh elements may be adapted by a mesh adaptation method (e.g., a local mesh adaptation method), for example, to obtain elements of the same size or at least substantially the same size and/or of good quality. A local mesh adaptation method may include applying local operations that replace a limited number of elements by other elements that altogether form a mesh of the same cavity as the initial elements but have a higher quality and/or a different size.

In one embodiment, at least one surface mesh (e.g., surface meshes made of boundaries of specimen, support, and environment regions within the build-up volume) is remeshed by replacing the at least one surface mesh with a new surface mesh of at least substantially uniform edge length. The at least one new surface mesh resulting from the remeshing may be used as seed mesh in generating new three-dimensional meshes (e.g., new tetrahedral meshes). In this way, elements of the same size or at least substantially the same size may be achieved.

The interior of the at least one specimen defined by the at least one specimen surface mesh may be meshed (e.g., in accordance with a discretization that is extracted from existing CAD data of the at least one specimen).

If a support surface mesh created in the identifying of the at least one support mesh and at least one environment mesh defines a closed volume, this volume may be meshed by a volume meshing technique. The resulting entire support mesh may include pyramid-shaped, hexahedron-shaped, cuboid-shaped, and/or tetrahedron-shaped mesh elements. In one embodiment, the entire support mesh is a tetrahedral mesh. If a support may be initially defined by a closed volume (e.g., closed faceting or brep solid geometry), the support may be meshed by classical volume meshing techniques. A volume of the support may not be part of the background mesh, and the support may be meshed in the same way as a specimen. This offers the possibility to obtain meshes that very accurately represent given geometrical models for a specific support. In the extreme case where all supports initially receive a closed geometrical model, the at least one powder mesh may still be obtained without requiring a geometrical model for the powder region.

The above mentioned meshing of the interior of the at least one specimen and/or of a closed volume defined by a support surface mesh may be performed after elimination of at least one bubble mesh and/or after improvement of a resulting mesh. For example, the above-mentioned meshing of the interior of the at least one specimen and/or of a closed volume defined by a support surface mesh may be the last act of the method of one or more of the present embodiments. However, it is also possible to mesh the interior of the at least one specimen when the at least one specimen mesh is provided in the providing of the at least one specimen mesh.

In principle, it is possible that the mesh elements of the at least one specimen mesh, the at least one support mesh, the structure mesh, and/or the at least one environment mesh have the same size and/or shape.

With the method of one or more of the present embodiments, a structure mesh and an environment mesh may be generated automatically without a user having to actively intervene in the generation process (e.g., without the necessity of manual interaction). As users do not have to interact during the mesh generation procedure, the users do not need to have any detailed knowledge on the mesh generation procedure, and thus do not have to be experts in the field of meshing techniques.

The present embodiments also include a use of a structure mesh of a structure generated according to the method of one or more of the present embodiments for simulating (e.g., thermal, mechanical, and/or thermos-mechanical simulating) an additive manufacturing build-up process (e.g., a powder bed fusion based build-up process) of the structure.

The present embodiments also include a computer program including instructions that, when the program is executed by at least one computer, cause the at least one computer to carry out the method of one or more of the present embodiments.

The present embodiments also include a computer-readable medium including instructions that, when executed on at least one computer, cause the at least one computer to perform the act of the method of one or more of the present embodiments.

The computer-readable medium may be, for example, a CD-ROM or DVD or a USB or flash memory. A computer-readable medium may not be understood exclusively as a physical medium, but such a medium may also exist in the form of a data stream and/or a signal representing a data stream.

### BRIEF DESCRIPTION OF THE DRAWINGS

FIGS. 1-5 are purely schematic illustrations illustrating acts of a method for generating a structure mesh according to a first embodiment;

FIG. 6 is a purely schematic illustration illustrating the act of identifying support meshes of a method for generating a structure mesh according to a second embodiment;

FIG. 7 is a spatial representation of a part of another kind of support arrangement by facetted surfaces;

FIG. 8 is a section view along section line VIII-VIII in FIG. 7 showing the support arrangement as built-up as well as simulated;

FIG. 9 is a spatial representation of yet another kind of support arrangement by facetted surfaces;

FIG. 10 a section view along section line X-X in FIG. 9 showing the support arrangement as build-up as well as simulated;

FIG. 11 is a spatial representation of yet another kind of support arrangement by facetted surfaces; and

FIG. 12 is a section view along section line XII-XII in FIG. 11 showing the support arrangement as build-up as well as simulated.

### DETAILED DESCRIPTION

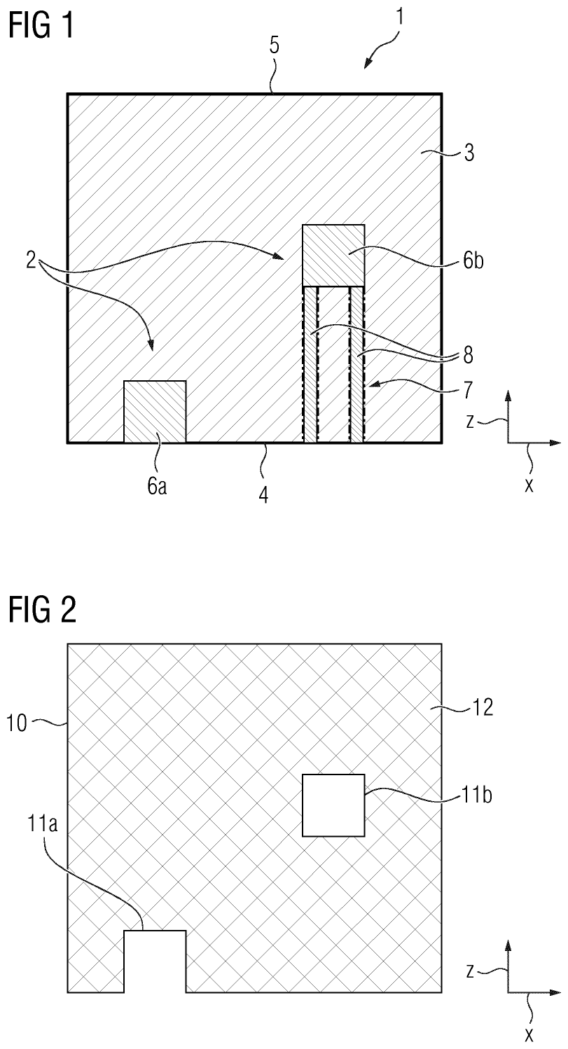

FIGS. 1-5 show a purely schematic illustration illustrating acts of a method according to a first embodiment. FIG. 1 shows an X-Z sectional view of a three-dimensional build-up volume 1 with a structure 2 in the three-dimensional build-up volume 1. The structure 2 has been built-up or is to be built-up by a powder bed based additive manufacturing build-up process that may be a selective laser melting (SLM) process. In the SLM process, a metal powder 3 to be processed is applied in a thin layer to a build-up platform 4 defining a lower part of a boundary 5 of the build-up volume 1 and then completely melted locally using a laser radiation so that a solid material layer is formed after solidification. The boundary 5 of the build-up volume 1 is partly shown in FIGS. 1 and 5, for example. For reasons of illustration, only four of the total of six boundary surfaces of the build-up volume 1 is shown in these figures. The above-mentioned procedure is repeated layer by layer until the desired structure 2 is completed. The structure 2 consists of two cuboid specimens 6a,b and a complex support arrangement 7 that includes two nearly columnar supports 8 and supports the specimen 6b shown in FIG. 1 on the right on the build-up platform 4. The supports 8 thus each extend at a distance from each other between the build-up platform 4 and the specimen 6b and connect the build-up platform 4 with the specimen 6b. The other specimen 6a shown in FIG. 1 on the left is directly placed on the build-up platform 4 without using any supports 8.

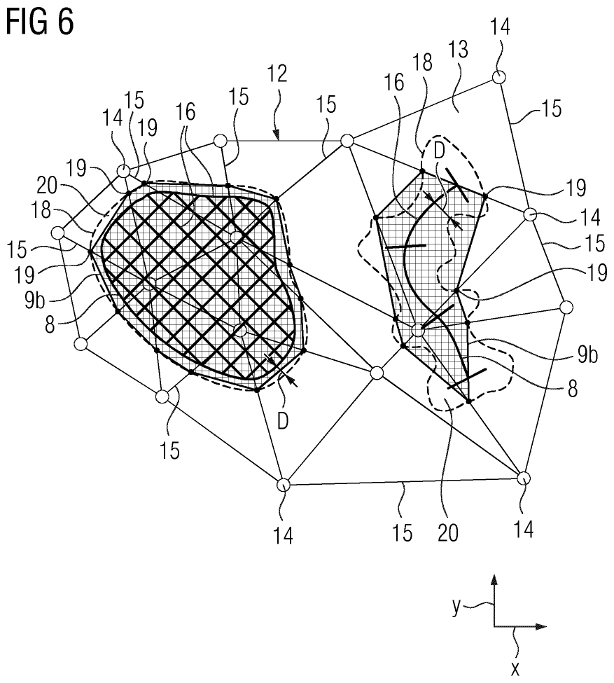

The method according to the first embodiment is used to generate a structure mesh 9 of the structure 2. The structure mesh 9 consists of two specimen meshes 9a and at least one support mesh 9b. First, a build-up volume surface mesh 10 that represents the boundary 5 of the three-dimensional build-up volume 1 is provided. Then, two specimen surface meshes 11a,b each representing the outer surface of a corresponding specimen 6a,b are provided within an interior space surrounded by the build-up volume surface mesh 10. The specimen surface meshes 11a,b are based on available CAD data of the specimens 6a,b. In a next act, a three-dimensional background mesh 12 is created in the cavity between the build-up volume surface mesh 10 and the two specimen surface meshes 11a,b using both specimen surface meshes 11a,b as two-dimensional seed meshes, as shown in FIG. 2. The resulting background mesh 12 is composed of tetrahedron-shaped elements 13 consisting of background mesh nodes 14 and background mesh edges 15 extending between the background mesh nodes 14. For the sake of simplicity, in the X-Z sectional views of FIGS. 1-5, the meshes are merely indicated by lines or squared areas. The squared areas are thus only intended to indicate that the respective area represents a mesh. The squares of the squared areas do not allow any conclusions to be drawn about the actual type or size of mesh elements and connections between meshes. Different sizes of squares only serve to distinguish different meshes and do not necessarily provide that the respective meshes have different mesh sizes. However, background mesh elements 13 are shown in connection with the second embodiment in FIG. 6. Using both specimen surface meshes 11a,b as seed meshes results in nodes and edges of the specimen surface meshes 11a,b to match background mesh nodes 14 and background mesh edges 15 at the outer boundary of the background mesh 12.

For both supports 8, only surface data (e.g., STL data), instead of CAD construction data, is available. This surface data describes facetted surfaces 16 of the two supports 8 and is to be converted into data of at least one solid geometry (e.g., volume data) that may be meshed. To achieve this, two support meshes 9b and one environment mesh 17 (e.g., a powder mesh) that is defined by the background mesh 12 except for regions of the two support meshes 9b are identified using the background mesh 12 and the surface data of the supports 8. More precisely, surfaces 18 of the two supports 8 are identified within the background mesh 12 by identifying points of intersection 19 of the surfaces 18 of the two supports 8 with background mesh edges 15. At the points of intersection 19, new nodes are created, and thus, the respective background mesh edges 15 are split. Then, at least some of the created new nodes are interconnected to create support meshes 9b and environment meshes 17. The surfaces 18 that intersect the background mesh edges 15 are surfaces 18 of a sub-volume 20 of the build-up volume 1 that represents the two supports 8 as simulated later in contrast to the facetted surfaces 16 of the two supports 8 and/or in contrast to the supports 8 as actually built-up in the additive manufacturing build-up process. The sub-volume 20 is defined as the set of points within the build-up volume 1 that are located at a distance inferior to a threshold D to the closest facet of the facetted surfaces 16 of the two supports 8. In the present example, the threshold D is chosen as the minimal distance such that any point located in the interior of the supports 8 is at most at a distance d to the closest facet of the facetted surfaces 16 of the two supports 8, where the value of d corresponds to the value of D. The sub-volume 20 and the threshold D are shown in FIGS. 6, 8, 10 and 12.

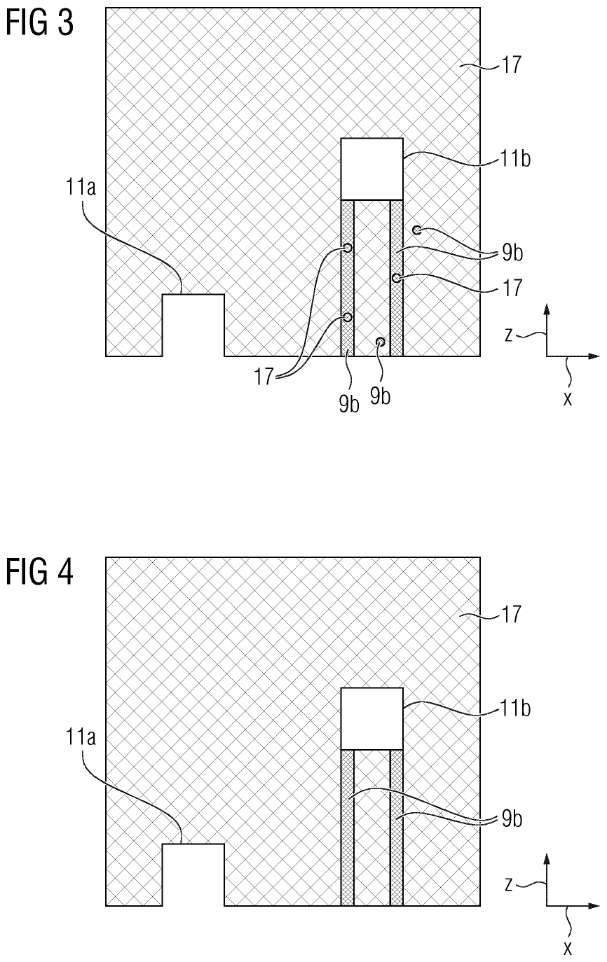

In the present example, four support meshes 9b and four environment meshes 17 are created, where two of the four support meshes 9b are support bubble meshes and three of the four environment meshes 17 are environment bubble meshes, as shown in FIG. 3. The support bubble meshes 9b are fully enclosed in the environment mesh 17, which is not an environment bubble mesh. Hence, the support bubble meshes 9b are neither connected to specimen 6b, nor to boundary 5, nor to another support mesh 9b. The environment bubble meshes 17 are each enclosed in one of the two support meshes 9b that are not support bubble meshes.

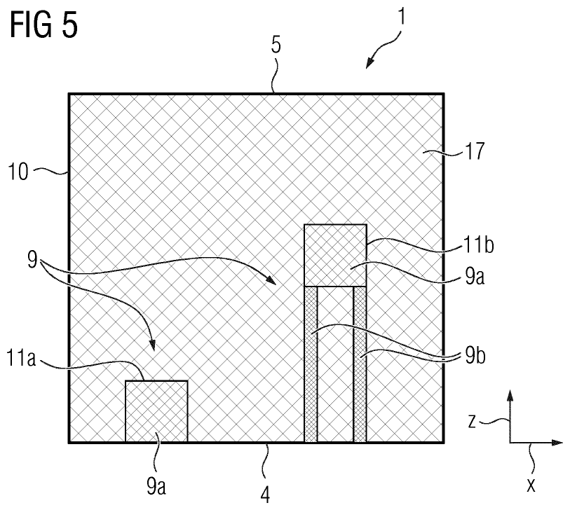

In the next act, the two support bubble meshes 9b are eliminated by making the two support bubble meshes 9b part of the only environment mesh 17 that is not an environment bubble mesh. Likewise, the three environment bubble meshes 17 are eliminated by making the three environment bubble meshes 17 part of the respective support mesh 9b in which the three environment bubble meshes 17 are enclosed. The result of this bubble elimination procedure is that only two support meshes 9b and one environment mesh 17 remain, which is shown in FIG. 4.

Thereafter, at least some of the resulting meshes are improved to meet a predefined element quality and element size. More precisely, surface meshes made of boundaries of specimen, support, and environment regions within the build-up volume 1 are remeshed. This is done by replacing a respective surface mesh (e.g., a surface mesh between the support 8a and/or support 8b and the powder environment) with a new surface mesh of at least substantially uniform edge length. The new surface mesh resulting from the remeshing may than be used as a seed mesh in generating a corresponding new three-dimensional mesh. Additionally or alternatively, the background mesh elements 13 may be adapted by a common mesh adaptation method.

Finally, the interior of the two specimens 6a,b defined by the specimen surface meshes 11a,b is meshed in accordance with a discretization that is extracted and/or taken over from the existing CAD data of the specimens 6a,b. Additionally or alternatively, if a support surface mesh of the support meshes 9a,b defines a closed volume, this closed volume may be meshed by a common volume meshing technique.

The structure mesh 9 is thus generated such that the two support meshes 9b, the two specimen meshes 9a, and the environment mesh 17 are connected with each other so that two neighboring meshes share the same nodes at their interfaces in their transition area. The generated structure mesh 9 may be used for simulating (e.g., thermal, mechanical, and/or thermos-mechanical simulating) the powder bed fusion based additive manufacturing build-up process of the structure 2. The embodiments of the method of the present embodiments described herein may also be used in conjunction with any other additive manufacturing build-up processes.

FIG. 6 shows a purely schematic illustration illustrating the act of identifying support meshes 9b of a method for generating a structure mesh 9 according to a second embodiment. Thereby, FIG. 6 represents an X-Z sectional view of a three-dimensional build-up volume 1. The method according to the second embodiment differs from the method according to the first embodiment only in that a different kind of support arrangement 7 is meshed (e.g., different support meshes 9b are identified). More precisely, the support arrangement 7 in the second embodiment consists of a block support 8 shown on the left side in FIG. 6 and a line support 8 shown on the right side in FIG. 6.

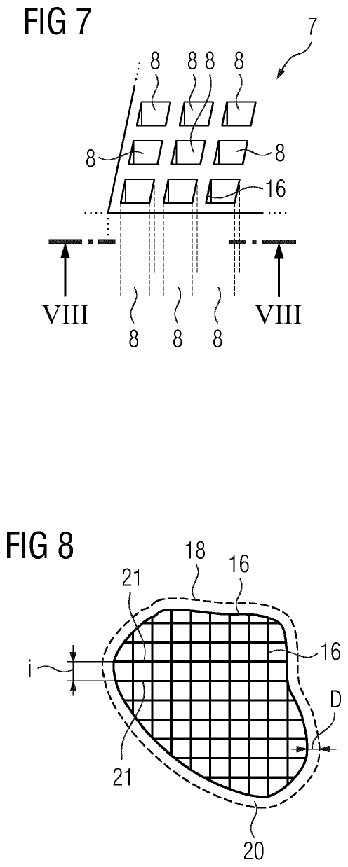

Another kind of support arrangement 7 shown in FIG. 7 includes a plurality of pipe-like supports 8 that may be seen as a grid-like structure in the section view of FIG. 8. In this example, the distance i between two adjacent grid lines 21 is equal to twice the threshold D (e.g., i=2D). Since the support arrangement 7 has a closed boundary, the value for D is chosen relatively small as compared to the support arrangements 7 shown in FIGS. 10 and 12.

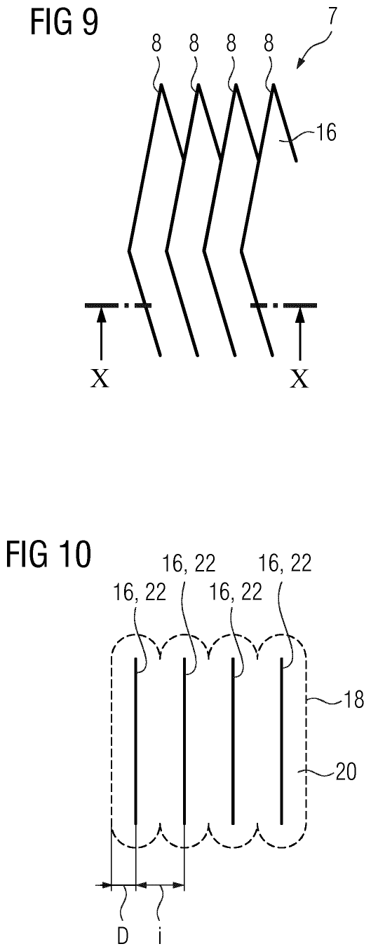

Yet another kind of support arrangement 7 shown in FIG. 9 includes four parallel wall-like supports 8 that may be seen as four parallel lines 22 in the section view of FIG. 10. In this example, the distance i between two adjacent lines 22 is equal to twice the threshold D (e.g., i=2D).

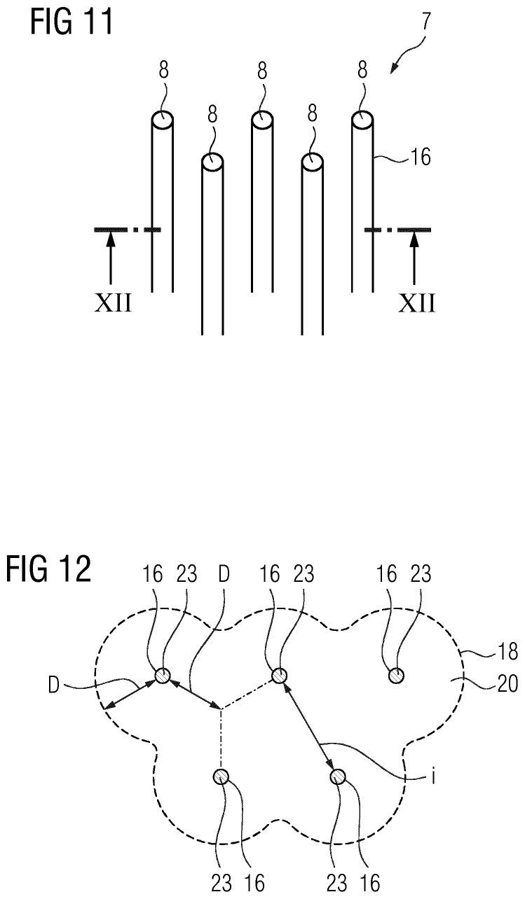

Yet another kind of support arrangement 7 shown in FIG. 11 includes five supports 8 in the form of parallel cylindrical columns that are shown as five dots 23 in the section view of FIG. 12. In this example, the distance i between two adjacent dots 23 is equal to the threshold D multiplied by cos(30°).

As shown, for example, in FIGS. 10 and 12, the support arrangement 7 consisting of the supports 8 represented by facetted surfaces 16 is converted into a volume that is a sub-volume 20 of the build-up volume 1 and represents the support arrangement 7 as a solid body.

Although the present invention has been described in detail with reference to the exemplary embodiments, it is to be understood that the present invention is not limited by the disclosed examples. Numerous additional modifications and variations may be made thereto by a person skilled in the art without departing from the scope of the invention.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method for generating a structure mesh of a structure that is to be built up in a three-dimensional build-up volume in an additive manufacturing build-up process, the structure comprising at least one specimen and at least one support for supporting the at least one specimen on a boundary of the build-up volume, wherein the structure mesh is usable in simulating the additive manufacturing build-up process of the structure, the method comprising:
providing a build-up volume surface mesh that represents the boundary of the three-dimensional build-up volume;
providing at least one specimen mesh including a specimen surface mesh representing at least an outer surface of a corresponding specimen within an interior space surrounded by the build-up volume surface mesh;
creating a three-dimensional background mesh in a cavity between the build-up volume surface mesh and the at least one specimen surface mesh using the at least one specimen surface mesh as a seed mesh, wherein the three-dimensional background mesh is composed of elements consisting of background mesh nodes and background mesh edges extending between the background mesh nodes; and
identifying at least one support mesh and at least one environment mesh that is defined by the background mesh except for regions of the at least one support mesh using the background mesh and surface data that describe a facetted surface of the at least one support,
wherein the at least one support mesh and the at least one specimen mesh together define the structure mesh that is generated such that the at least one support mesh, the at least one specimen mesh, and the at least one environment mesh are connected with each other so that two neighboring meshes share same nodes at interfaces in a transition area.

2. The computer-implemented method of claim 1, wherein:
providing the at least one specimen mesh comprises providing at least one three-dimensional specimen mesh that represents a discretization not only of the surface of the at least one specimen but of the entire volume of the at least one specimen, and creating the three-dimensional background mesh comprises discretizing the cavity with background mesh elements having a same size, shape, or size and shape as three-dimensional specimen mesh elements of the at least one three-dimensional specimen mesh;
creating the three-dimensional background mesh comprises creating a three-dimensional background mesh having background mesh elements that are tetrahedron-shaped, pyramid-shaped, hexahedron-shaped, cuboid-shaped, or any combination thereof; or
a combination thereof.

3. The computer-implemented method claim 1, wherein creating the three-dimensional background mesh comprises creating a background mesh having smaller elements in a region of the three-dimensional build-up volume where the at least one support is expected to be located, and larger elements outside the region.

4. The computer-implemented method of claim 1, wherein identifying the at least one support mesh comprises identifying surfaces of the at least one support within the background mesh, the identifying of the surfaces comprising identifying points of intersection of the surfaces of the at least one support with background mesh edges, creating new nodes at the points of intersection, thus splitting the respective background mesh edges, and interconnecting at least some of the new nodes to create at least one support surface mesh.

5. The computer-implemented method of claim 4, wherein the identified surfaces of the at least one support are surfaces of a sub-volume of the three-dimensional build-up volume that represent the at least one support as simulated in contrast to the at least one support as actually built-up in the additive manufacturing build-up process.

6. The computer-implemented method of claim 5, wherein the sub-volume of the three-dimensional build-up volume that represents the at least one support as simulated is defined as the set of points within the three-dimensional build-up volume that are located at a distance inferior to a threshold to a closest facet of the facetted surface of the at least one support described by the surface data,
wherein the threshold is selectable as a minimal distance such that any point located in an interior of the at least one support is at most at a distance to the closest facet of the at least one support, and
wherein a value of the distance corresponds to a value of the threshold.

7. The computer-implemented method of claim 1, wherein:
identifying the at least one support mesh and the at least one environment mesh comprises identifying an environment mesh that is an environment bubble mesh enclosed in a support mesh, the environment bubble mesh being eliminated by making the environment bubble mesh part of the support mesh in which the environment bubble mesh is enclosed;
identifying the at least one support mesh and the at least one environment mesh comprises identifying a support mesh that is a support bubble mesh not connected to the at least one specimen nor a build-up volume boundary, wherein the support bubble mesh is eliminated by making the support bubble mesh part of the at least one environment mesh; or
a combination thereof.

8. The computer-implemented method of claim 7, wherein after eliminating bubble meshes, at least one resulting mesh is improved to meet a predefined element quality and element size.

9. The computer-implemented method of claim 8, wherein the background mesh elements are adapted by a mesh adaptation method.

10. The method of claim 8, further comprising remeshing at least one surface mesh, the remeshing of the at least one surface mesh comprising replacing the at least one surface mesh with a new surface mesh of at least substantially uniform edge length,
wherein the at least one new surface mesh resulting from the remeshing is used as seed mesh in generating new three-dimensional meshes.

11. The method of claim 1, wherein an interior of the at least one specimen defined by the at least one specimen surface mesh is meshed.

12. The method of claim 4, wherein a support surface mesh defines a closed volume that is meshed by a volume meshing technique.

13. A method comprising:
using a structure mesh of a structure for simulating an additive manufacturing build-up process of the structure, the structure comprising at least one specimen and at least one support for supporting the at least one specimen on a boundary of a build-up volume, generation of the structure comprising provision of a build-up volume surface mesh that represents the boundary of the build-up volume, provision of at least one specimen mesh including a specimen surface mesh representing at least an outer surface of a corresponding specimen within an interior space surrounded by the build-up volume surface mesh, creation of a three-dimensional background mesh in a cavity between the build-up volume surface mesh and the at least one specimen surface mesh using the at least one specimen surface mesh as a seed mesh, wherein the three-dimensional background mesh is composed of elements consisting of background mesh nodes and background mesh edges extending between the background mesh nodes, and identification of at least one support mesh and at least one environment mesh that is defined by the background mesh except for regions of the at least one support mesh using the background mesh and surface data that describe a facetted surface of the at least one support, wherein the at least one support mesh and the at least one specimen mesh together define the structure mesh that is generated such that the at least one support mesh, the at least one specimen mesh, and the at least one environment mesh are connected with each other so that two neighboring meshes share same nodes at interfaces in a transition area.

14. (canceled)

15. In a non-transitory computer-readable storage medium that stores instructions executable by at least one computer to generate a structure mesh of a structure that is to be built up in a three-dimensional build-up volume in an additive manufacturing build-up process, the structure comprising at least one specimen and at least one support for supporting the at least one specimen on a boundary of the build-up volume, wherein the structure mesh is usable in simulating the additive manufacturing build-up process of the structure, the instructions comprising:
providing a build-up volume surface mesh that represents the boundary of the three-dimensional build-up volume;
providing at least one specimen mesh including a specimen surface mesh representing at least an outer surface of a corresponding specimen within an interior space surrounded by the build-up volume surface mesh;
creating a three-dimensional background mesh in a cavity between the build-up volume surface mesh and the at least one specimen surface mesh using the at least one specimen surface mesh as a seed mesh, wherein the three-dimensional background mesh is composed of elements consisting of background mesh nodes and background mesh edges extending between the background mesh nodes; and
identifying at least one support mesh and at least one environment mesh that is defined by the background mesh except for regions of the at least one support mesh using the background mesh and surface data that describe a facetted surface of the at least one support,
wherein the at least one support mesh and the at least one specimen mesh together define the structure mesh that is generated such that the at least one support mesh, the at least one specimen mesh, and the at least one environment mesh are connected with each other so that two neighboring meshes share same nodes at interfaces in a transition area.

16. The computer-implemented method of claim 1, wherein the at least one support is for supporting the at least one specimen on a build-up platform that defines a lower part of the boundary of the build-up volume.

17. The computer-implemented method of claim 3, wherein the region is a region defined by a geometrical bounding box that encloses the at least one support and comprises all elements thereof.

18. The computer-implemented method of claim 7, wherein the environment mesh is a powder mesh.

19. The computer-implemented method of claim 9, wherein the mesh adaptation method is a local mesh adaptation method.

20. The computer-implemented method of claim 10, wherein the at least one surface mesh comprises surface meshes made of boundaries of specimen, support, and environment regions within the three-dimensional build-up volume.

21. The method of claim 11, wherein the interior of the at least one specimen defined by the at least one specimen surface mesh is meshed in accordance with a discretization that is extracted from existing CAD data of the at least one specimen.
